(19) United States
(12) Patent Application Publication
(10) Pub. No.: US 2019/0011057 A1
(43) Pub. Date: Jan. 10, 2019

(54) SPRING RETURN THROTTLE ACTUATOR, METHOD OF CONTROL THEREOF AND THROTTLE ASSEMBLY

(71) Applicant: Scania CV AB, Södertälje (SE)

(72) Inventors: Fredrik STRÅÅT, Stockholm (SE); Sebastian ZAMANI, Stockholm (SE)

(73) Assignee: Scania CV AB, Södertälje (SE)

(21) Appl. No.: 16/066,636

(22) PCT Filed: Dec. 12, 2016
(86) PCT No.: PCT/SE2016/051247

§ 371 Date: Jun. 27, 2018

(30) Foreign Application Priority Data
Jan. 5, 2016 (SE) 1650012-6

(51) Int. Cl. F16K 31/04; F02D 9/10; H02P 3/12; H02P 6/08; H02P 6/17; H02P 6/24

(52) U.S. Cl. CPC F16K 31/046; F02D 9/105; F02D 9/1065; H02P 6/24; H02P 6/085; H02P 6/17; H02P 3/12

(57) ABSTRACT

A spring return throttle actuator including: an electric, plural-coil DC motor having an output shaft, a throttle return spring, a gear transmission connected to the output shaft, a control unit adapted to control power supply to the DC motor, wherein the spring return throttle actuator has a movement range between closed throttle and opened throttle. The control unit is arranged to short-circuit at least two DC motor coils in order to create a DC motor return resist torque, and the return spring is balanced such that generated spring return torque over the whole movement range of the actuator does not exceed said DC motor return resist torque. The invention also relates to a method and a throttle assembly.

### CROSS-REFERENCE TO RELATED APPLICATION(S)

This application is a National Stage Application (filed under 35 § U.S.C. 371) of PCT/SE2016/051247, filed Dec. 12, 2016 of the same title, which, in turn claims priority to Swedish Application No. 1650012-6 filed Jan. 5, 2016 of the same title; the contents of each of which are hereby incorporated by reference.

### FIELD OF THE INVENTION

The invention relates to a spring return throttle actuator including: an electric, plural-coil, DC motor having an output shaft, a throttle return spring, a gear transmission connected to the output shaft, a control unit adapted to control power supply to the DC motor, wherein the actuator has a movement range between closed throttle and opened throttle. The invention also relates to a method for control thereof and a throttle assembly.

### BACKGROUND OF THE INVENTION

Throttle assemblies are employed to control gas streams in respect of vehicle engines. The electric motor of the actuator is typically supplied with an electric current to switch from a normally open to a closed throttle position or from a normally closed to an open throttle position.

It could be mentioned that in respect of for example an air inlet throttle valve, the throttle is normally open whereas in an EGR valve the throttle is normally closed.

As a rule, the spring forces the throttle to a determined “normal” position which will guarantee operation also in the event that the electric motor is without current. It is thereby an aim to maintain the required exhaust gas values etc.

In the background art throttle assembly, for reaching intermediate positions between closed throttle and fully opened throttle, the electric motor is supplied with current to create a dynamic electromotive force which is balanced by the control unit to obtain a desired stationary throttle position between closed throttle and fully open throttle.

One problem with this previously known solution is that heat is generated in respect of the electrically driven actuator and that the components involved are difficult to cool, in particular in diesel engines where the environment around the actuator suffers from heat generated by the diesel engine itself. Unfortunately, high temperatures in the control electronics makes it more difficult to obtain desired working life.

Previous measures to remedy this problem have been directed to enhance cooling of sensitive elements. It may also be possible to reduce spring dimensions and the spring constant thereof to reduce level of current required to be supplied to the actuator. These measures are, however, not always unproblematic for different reasons.

### SUMMARY OF THE INVENTION

It is an aim of the present invention to provide a throttle actuator according to the above wherein the problems of the background art are addressed and at least reduced. This aim is obtained in a throttle actuator according to the above in that the control unit is arranged to short-circuit at least two DC motor stator coils in order to create a DC motor return resist torque, and that the return spring is balanced such that generated spring return torque over the whole movement range of the actuator does not exceed said DC motor return resist torque.

With the term “DC motor return resist torque” is meant that a counteracting electromotive force is generated which resists return torque generated by the spring. Furthermore, with the feature that the return spring is balanced is meant that the return spring is configured and dimensioned so as to generate a spring return torque within determined limits.

It should be realized that the return spring force must be selected in relation to:

1. In case of direct motor drive: The motor return resist torque when two or more coils are short-circuited;

2.In case of assembly motor and transmission drive: The assembly return resist torque when two or more coils are short-circuited.

Hereby the rotor becomes practically rotationally immovable, resulting in that the actuator and thereby the throttle is lockable in chosen intermediate positions, between fully opened and fully closed as well as in the end positions, without current consumption.

This means that in order to maintain an intermediate position constantly of the actuator, coils of the DC motor are short-circuited when in a desired position of the throttle which results in that the electric motor becomes rotationally stiff because of the occurrence of a great electromotive force and that the desired position of the throttle is maintained.

In order to securely maintain the throttle in the chosen position, rotational stiffness of the electric motor is thus required. The motor can thereupon, after terminating the short-circuit, be regulated such when the short-circuiting is terminated that 1) the spring moves the throttle in the direction towards the “normal” position, or 2) the motor is supplied with current such as to move the throttle against the spring action in the direction even more from the “normal” position.

In order to obtain 1), the spring force must of course be great enough to exceed the mechanical counter-force when the electric motor is not short-circuited.

In other words, according to the invention is thus obtained that the desired position is obtained without having to apply current to the coils of the engine. Instead, the motor itself will maintain the position because of the short-circuited coils.

This is highly advantageous since the electric motor and the control electronics will be subjected to less current supply which is a positive factor i.e. for the working life of these elements.

Furthermore, the energy required for the electric motor and the control electronics will be reduced which is a positive factor for temperature reduction and also for fuel consumption.

Suitably the DC motor includes three coils and all three coils may be subject to short-circuiting.

The control unit preferably includes a bridge circuit having one branch connected to each one of the coils. This circuitry makes the actuator easily controlled in an economic and logical manner. This advantage is even more enhanced when each branch includes a transistor switch connected to each one of the coils.

At least one movement sensor is preferably positioned to detect DC motor rotor movements in order to guarantee stability and maintained settings and adjustability. In particular it is advantageous when a plurality of Hall sensors is positioned to detect DC motor rotor movements, the Hall sensors of said plurality being distributed around the rotor to increase measurement accuracy. The sensors can also be positioned such that they detect the position of the throttle itself or an element of the transmission, since the position of the motor can be derived therefrom.

In an inventive method of controlling a spring return throttle actuator, wherein the actuator includes: an electric, plural-coil, DC motor having an output shaft, a throttle return spring, a gear transmission connected to the output shaft, a control unit adapted to control power supply to the DC motor,

wherein the actuator has a movement range between closed throttle and fully opened throttle,

at least two DC motor coils are short-circuited by the control unit in order to create a DC motor return resist torque being of such a magnitude that generated spring torque, from a balanced return spring, over the whole movement range of the actuator does not exceed said DC motor return resist torque. Advantages corresponding to the above are obtained.

All three coils are preferably short-circuited.

The coils are preferably supplied with power from each one branch of a bridge circuit being included in the control unit.

Advantageously each branch is switched through separate transistor switches.

DC motor rotor movements are preferably detected by at least one movement sensor and more preferred by a plurality of Hall sensors being rotationally distributed to increase measurement accuracy.

The invention also relates to a throttle assembly including a throttle, a throttle actuator and a control unit wherein the throttle actuator is according to what is stated above.

Further features of and advantages of the invention will be explained below at the background of embodiments.

### BRIEF DESCRIPTION OF DRAWINGS

The invention will now be described in greater detail by way of embodiments and with reference to the annexed drawings, wherein:

FIG. 1 illustrates a throttle assembly including a spring return throttle actuator according to the invention,

FIG. 2 shows a control circuit for the inventive throttle actuator, and

FIG. 3 shows a simplified flow chart over an inventive method.

### DETAILED DESCRIPTION OF THE INVENTION

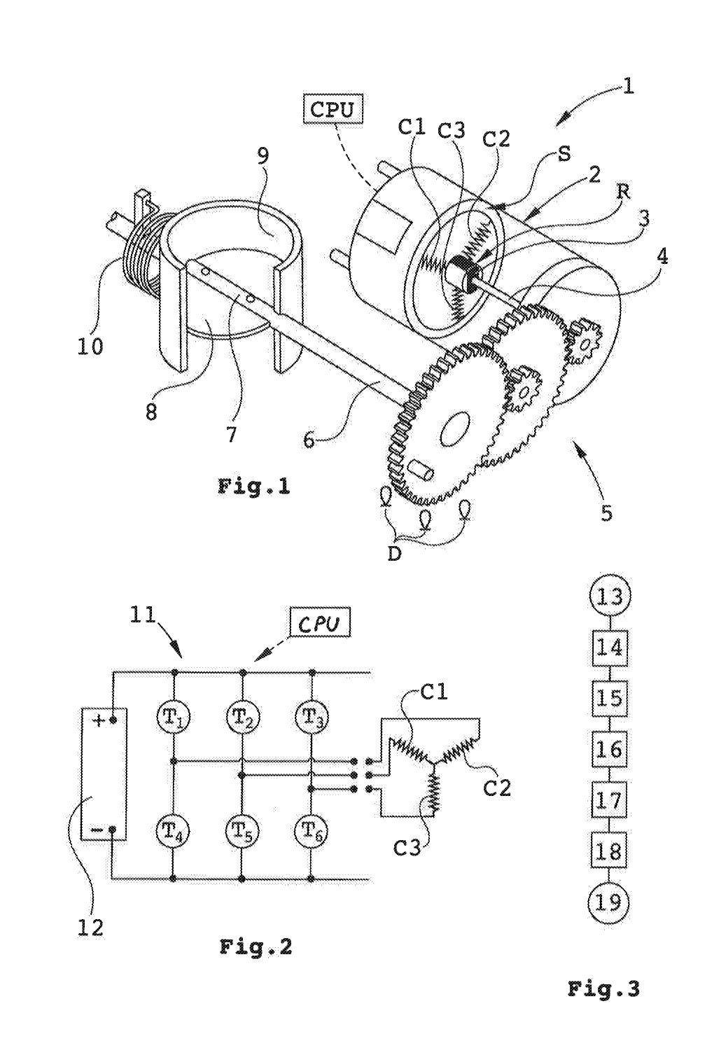

FIG. 1, shows a throttle assembly whereof a spring return throttle actuator is generally depicted with reference number 1. The actuator 1 includes a DC motor 2 having three coils C1, C2 and C3 in its stator S. The rotor R is as usual provided with a permanent rotor magnet 3 and an output shaft 4.

A gear transmission 5 is connected to the output shaft 4 and an outgoing shaft 6 from the gear transmission 5 is coupled with its distal end to a throttle shaft 7 of a throttle 8. The actuator has a movement range between closed throttle and fully opened throttle.

It should be noted that the motor also could be directly connected to the throttle.

The throttle 8 is arranged in a channel 9 to control a gas stream flowing through the channel 9.

A throttle return spring 10 is positioned around the outgoing shaft 6 and functions to provide a spring torque urging the outgoing shaft 6 to rotate towards a “normal” position of the throttle 8 which may be fully open or fully closed depending on the nature of the throttle as explained above.

A control unit CPU is connected to the DC motor and is adapted to control supply of power to the DC motor and thereby to control the throttle position. Movement sensors, preferably Hall effect sensors, are indicated with D.

FIG. 2 illustrates a bridge circuit 11 positioned between a 24 Volts current source 12 for the supply of power to the three coils C1, C2 and C3 of the DC motor 3.

The bridge circuit includes a set of transistor switches T₁-T₆ that are made conductive-nonconductive to controllably power supply the DC motor 3.

In order to short-circuit all coils C1, C2 and C3, the transistor switches T₁-T₆ are made conductive and electric voltage is cut off. It is possible to make variations of the duration of conductivity of the transistor switches in order to apply force of different magnitudes by varying and by controlling transistor switches. It is also possible to short-circuit only two of the coils, whereby obviously a reduced rotation resist torque will arise compared to when all three coils are short-circuited.

It is possible to receive information from the DC motor and associated cables about its operation. If the motor is rotated, the rotational speed is directly proportional to the voltage. It is also possible to measure voltage which momentarily results in knowledge of rotational speed. For detection of rotational position of the rotor of the motor, a plurality of detectors are preferably being used. This gives information about throttle position.

The detectors are suitably stationary co-operate for example with a ring being rotationally associated with the rotor or with one of the shafts, said ring having a great number of evenly distributed marks or holes. Monitoring the durations between pulses from three distributed mark or hole detectors results in information of position and rotational speed. There is also a possibility to detect rotor acceleration if required for some reason.

In the simplified flow chart in FIG. 3, an exemplary method sequence related to the invention is briefly illustrated.

13 indicates start of sequence.

14 indicates evaluating flow requirements through a channel.

15 indicates calculating desired throttle position.

16 indicates initiating DC motor to position throttle in desired position.

17 indicates verifying that throttle has reached the desired position.

18 indicates initiating circuit to short-circuit DC motor coils to lock throttle.

19 indicates end of sequence.

The sequence may be supplemented with additional steps and is repeated as required.

The invention can be modified within the scope of the annexed claims. For example, the control circuitry can be laid out differently as can be the DC motor, for instance, the number of coils of the DC motor can be other than three. The feature “closed throttle” is intended to include a case with totally blocked opening as well as a case with a certain minimum opening that might exist. With the feature “opened throttle” is intended the maximum opening achievable for the throttle in question.

Different kinds of sensors may be employed and they can be positioned in various places in association with the throttle assembly, for example close to the throttle itself.

1. A spring return throttle actuator having a movement range between a closed throttle and an opened throttle:
an electric, plural-coil DC motor having an output shaft;
a throttle return spring;
a gear transmission connected to the output shaft; and
a control unit adapted to control power supply to the DC motor, wherein
the control unit is configured to short-circuit at least two DC motor coils of said DC motor to create a DC motor return resist torque, and
wherein the return spring is balanced such that generated spring return torque over a whole movement range of the actuator does not exceed said DC motor return resist torque.

2. An actuator according to claim 1, wherein the DC motor comprises.

3. An actuator according to claim 1, wherein the control unit comprises a circuit comprising a plurality of branches, with one branch connected to each one of the coils.

4. An actuator according to claim 3, wherein each branch of said circuit includes a transistor switch connected to each one of the coils.

5. An actuator according to claim 1, wherein at least one movement sensor is positioned to detect DC motor rotor movements.

6. An actuator according to claim 5, wherein a plurality of Hall sensors are positioned to detect DC motor rotor movements, said plurality of Hall sensors being rotationally distributed to increase measurement accuracy.

7. A method of controlling a spring return throttle actuator having a movement range between a closed throttle and an opened throttle, wherein said actuator comprises: an electric, plural-coil DC motor having an output shaft, a throttle return spring a gear transmission connected to the output shaft and a control unit adapted to control power supply to the DC motor, wherein said method comprises:
short-circuiting at least two DC motor coils of said DC motor to create a DC motor return resist torque being of such a magnitude that a generated spring torque, from a balanced return spring, over a whole movement range of the actuator does not exceed said DC motor return resist torque.

8. A method according to claim 7, wherein the DC motor includes three coils, wherein short-circuiting comprises short-circuiting all three coils.

9. A method according to claim 7, wherein further comprising supplying power to the coils of said DC motor with power from a circuit comprising a plurality of branches, with one branch connected to each one of the coils.

10. A method according to claim 9, wherein each branch of said circuit is switched through separate transistor switches.

11. A method according to claim 7, further comprising monitoring movement of the rotor of said DC motor using at least one movement sensor.

12. A method according to claim 11, wherein monitoring movement of the rotor of said DC motor are performed using a plurality of Hall sensors distributed around the rotor to increase measurement accuracy.

13. A throttle assembly including a throttle, a spring return throttle actuator having a movement range between a closed throttle and an opened throttle, said actuator comprising:
an electric, plural-coil DC motor having an output shaft;
a throttle return spring;
a gear transmission connected to the output shaft; and
a control unit adapted to control power supply to the DC motor, wherein the control unit is configured to short-circuit at least two DC motor coils of said DC motor to create a DC motor return resist torque, and
wherein the return spring is balanced such that generated spring return torque over a whole movement range of the actuator does not exceed said DC motor return resist torque.

14. An actuator according to claim 13, wherein the DC motor comprises three
coils.

15. An actuator according to claim 13, wherein the control unit comprises a circuit comprising a plurality of branches, with one branch connected to each one of the coils.

16. An actuator according to claim 15, wherein each branch of said circuit includes a transistor switch connected to each one of the coils.

17. An actuator according to claim 13, wherein at least one movement sensor is positioned to detect DC motor rotor movements.

18. An actuator according to claim 17, wherein a plurality of Hall sensors are positioned to detect DC motor rotor movements, said plurality of Hall sensors being rotationally distributed to increase measurement accuracy.
